(19) United States
(12) Patent Application Publication
(10) Pub. No.: US 2010/0063786 A1
(43) Pub. Date: Mar. 11, 2010

(54) Co-Simulation Process

(76) Inventor: Michael C. Harke, Madison, WI (US)

Correspondence Address: STEPHEN GEORGE MICAN, Post Office Box 803338, #8973, Chicago, IL, 60680-3338, US

(21) Appl. No.: 12/208,384

(22) Filed: Sep. 11, 2008

(51) Int. Cl. G06G 7/48

(52) U.S. Cl. 703/6

(57) ABSTRACT

A method of communication and interaction between multiple simulations of a complex simulation system, each simulation comprising a model of a physical subsystem or parameter of the complex simulation system, comprises the steps of: transmitting from at least one transmitting simulation an output of its model to generate a simulation output signal; attenuating the simulation output signal above a maximum desired communication frequency between the simulations to generate a corresponding filtered simulation output signal; sampling the filtered simulation output signal at a sampling rate with a frequency at least twice the maximum desired communication frequency to generate a corresponding sampled output signal; transferring the sampled output signal from the transmitting simulation to at least one receiving simulation; conditioning the sampled output signal to generate a simulation input signal; and transferring the simulation input signal to the model of the receiving simulation.

### FIELD OF THE INVENTION

The invention relates to simulation systems for simulating systems or subsystems, and more particularly to interaction processes for two or more simulation models or packages within such simulation systems.

### BACKGROUND OF THE INVENTION

A simulation system comprises an electronic computer-based simulation of a complex physical system. A simulation system may comprise multiple simulations, each of which may comprise simulated parameters or subsystems of the simulated physical system. Co-simulation allows for two or more simulations of the simulation system to interact with each other. In practice, such co-simulation generally comprises a co-simulation interface between software packages, each software package serving as a distinct simulation.

### SUMMARY OF THE INVENTION

The invention generally comprises a method of communication and interaction between multiple simulations of a complex simulation system, each simulation comprising a model of a physical subsystem or parameter of the complex simulation system, comprising the steps of: transmitting from at least one transmitting simulation an output of its model to generate a simulation output signal; attenuating the simulation output signal above a maximum desired communication frequency between the simulations to generate a corresponding filtered simulation output signal; sampling the filtered simulation output signal at a sampling rate with a frequency at least twice the maximum desired communication frequency to generate a corresponding sampled output signal; transferring the sampled output signal from the transmitting simulation to at least one receiving simulation; conditioning the sampled output signal to generate a simulation input signal; and transferring the simulation input signal to the model of the receiving simulation.

### DESCRIPTION OF THE DRAWINGS

FIG. 1 is a general block diagram of a simulation system that may represent a complex physical system.

FIG. 2 is a block diagram of a simulation system according to a first possible embodiment of the invention.

FIG. 3 is a simulation system according to a second possible embodiment of the invention.

### DETAILED DESCRIPTION OF THE INVENTION

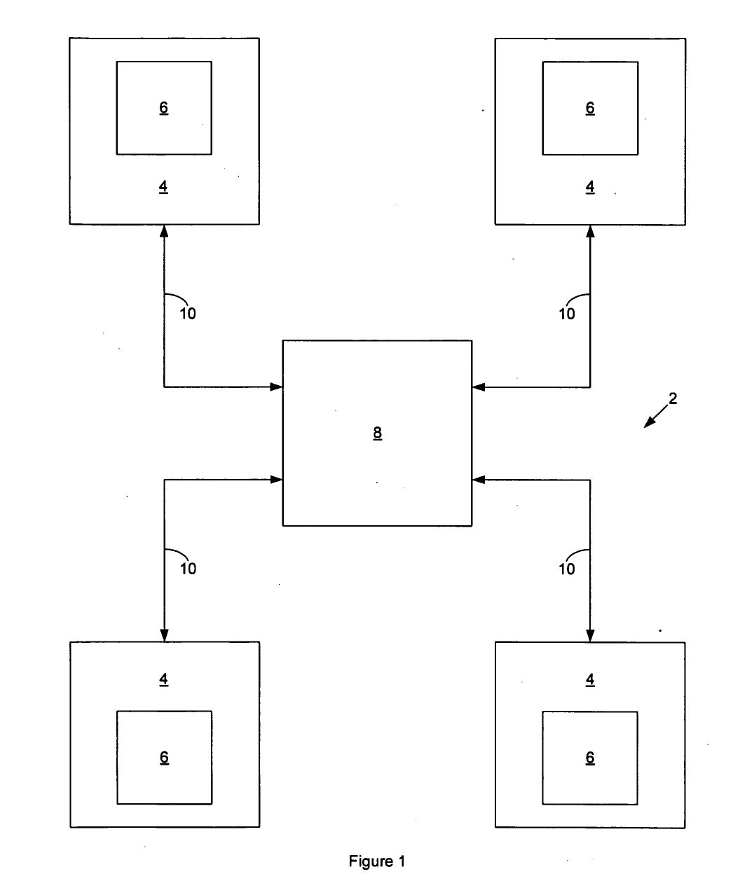

FIG. 1 is a general block diagram of a simulation system 2 according to a first possible embodiment of the invention that may represent a complex physical system. The simulation system 2 may comprise multiple simulations 4, each of which may comprise a model 6 that represents one or more simulated parameters or subsystems of the complex physical system that the simulation system 2 represents.

Co-simulation for the simulation system 2 requires interaction between its component simulations 4. Such interaction requires bi-directional communications between the component simulations 4 by way of a co-simulation interface 8 that couples the simulations 4, such as by communication buses 10. In practice, the co-simulation interface 8 transfers between the component simulations 4 samples of simulation signals that each component simulation 4 generates.

Operation in a discrete-time domain allows the simulations 4 to communicate with each other over the co-simulation interface 8 using a single communication channel with time domain multiplexing. However, such discrete-time domain operation requires sampling of the simulation signals of the simulations 4 as part of the time domain multiplexing process.

The key issue in specifying the sample rate of such simulation signal sampling is the understanding of the simulation and simulation objectives in order to determine the maximum frequency content conveyed between the component simulations. The Nyquist Limit requires that the sample frequency must be at least a factor of two higher than the maximum desired frequency of the sampled simulation signals, and it is typically an order of magnitude higher, or ten times, the maximum desired frequency of the sampled simulation signals. For example, communication of a simulation signal from one simulation 4 to another simulation 4 over the co-simulation interface 8 with a maximum desired frequency of 100 Hz requires a sampling rate greater than or equal to 200 Hz. With 200 Hz sampling, the Nyquist Frequency is 100 Hz. This permits communication of the 100 Hz simulation signal in the form of a simple square wave. A more complex signal with a fundamental frequency of 100 Hz would require a much higher sampling rate to accurately preserve amplitude and phase information. Depending on fidelity requirements, such a 100 Hz waveform may require a sample rate of 1000 Hz or more.

If a discrete-time control system comprises one of the simulations 4 in the simulation system 2, then there is an additional constraint in selecting the sample rate. In this case, the communication rate between the simulation 4 with a discrete-time controller model and the simulations 4 that represent the remaining models in the simulation system 2 should be an integer multiple of the selected discrete-time sample rate. For example, if the co-simulation interface 8 interfaces a simulation 4 with a continuous time domain model with another simulation 4 with a discrete-time controller model that has a sample rate of 10 kHz, then the communication rate should be the same as the sampling rate or an integer multiple thereof. If there are additional simulations 4 with continuous time domain models in the simulation system 2, the communication rate may then be an integer number of the sampling rate, depending on the required fidelity between the simulations 4 with continuous time domain models.

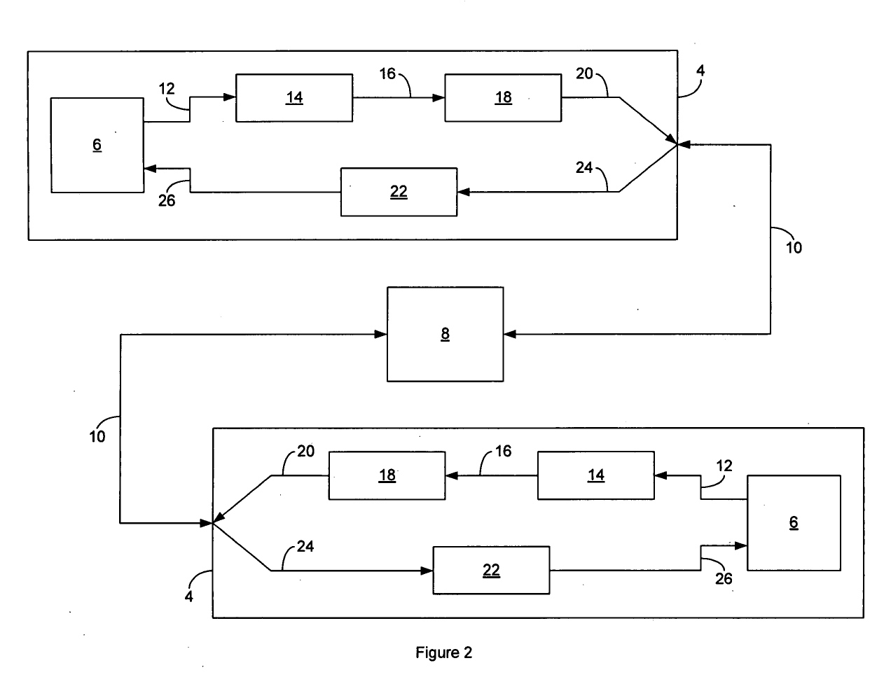

FIG. 2 is a block diagram of a simulation system 2 according a first possible embodiment of the invention with two simulations 4, each with a continuous time domain model 6 that interfaces with a discrete time domain communication interface 8 by way of corresponding communication buses 10. Each model 6 produces a continuous time domain simulation output signal x(t) on a model output line 12. An anti-aliasing filter 14 receives the simulation output signal x(t) on the model output line 12. Assuming that the maximum frequency of interest in the simulation output signal x(t) is of frequency f, the anti-aliasing filter 14 will sharply attenuate content in the simulation output signal x(t) higher in frequency than frequency f to produce a filtered simulation output signal x_{f}(t) on an anti-alias filter output line 16. The anti-aliasing filter 14 may be a suitable low-pass filter.

A sampler 18 receives the filtered simulation output signal x_{f}(t) on the anti-alias filter output line 16 and samples and holds values of the filtered simulation output signal x_{f}(t) at a selected sampling rate k with a frequency of at least the Nyquist Rate, or 2f to produce a sampled simulation output signal X_{f}(k) on a sampler output line 20.

The co-simulation interface 8 receives the sampled simulation output signal from the sampler output line 20 and transfers it to another simulation 4 by way of respective communication buses 10. A signal reconstruction filter 22, typically a low-pass filter, may receive the sampled simulation output signal from its respective communication bus 10 on a reconstruction filter input line 24. The signal reconstruction filter 22 may filter or smooth the sampled simulation output signal that it receives as a continuous time domain to produce a simulation input signal on a reconstruction filter output line 26. The model 6 receives the simulation input signal on the reconstruction filter output line 26, thereby letting the models 6 of the simulations 4 to communicate and interact.

A disadvantage to the simulation system 2 is required bandwidth of the co-simulation interface 8 and the communications buses 10. If a model 6 of a simulation 4 has continuous time domain output signal with an alternating current (AC) characteristic with a relatively high fundamental frequency, the co-simulation interface 8 and the communications buses 10 will have to accommodate a bandwidth that is at least twice, and possibly ten times or more, this fundamental frequency bandwidth. The co-simulation interface 8 and the communications buses 10 would be able to operate at a greatly reduced bandwidth if the simulation output signals of the models 6 could convey the same information at baseband or near direct current (DC) levels.

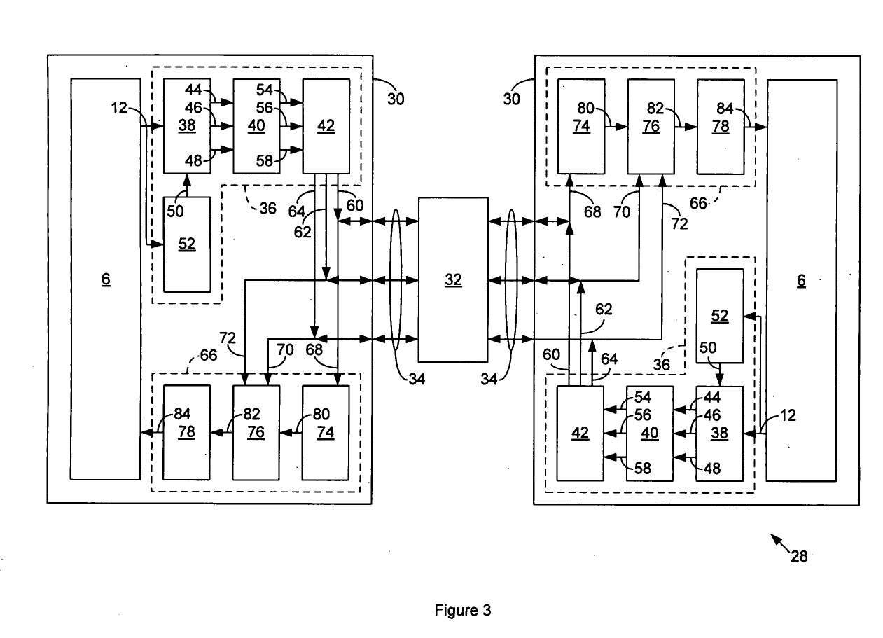

FIG. 3 is a simulation system 28 according to a second embodiment of the invention that so limits required bandwidth of communication and interaction between simulations 30. By way of example only, FIG. 3 shows the simulation system 28 with two multi-channel simulations 30 that communicate and interact with each other by way of a multi-channel co-simulation interface 32 and respective multi-channel communication buses 34. The simulation system 28 may have any desired number of such simulations 30.

Each simulation 30 comprises a continuous time domain model 6 that represents one or more simulated parameters or subsystems of the complex physical system that the simulation system 30 represents. Each model 6 produces a continuous time domain simulation output signal x_{ac}(t) on a model output line 12 that has a significant alternating current (AC) characteristic that occurs at a dominant or fundamental frequency. An output processor 36 receives the simulation output signal x_{ac}(t) on the model output line 12. The output processor 36 comprises a synchronous rotating reference frame transform 38, an anti-alias filter 40 and a sampler 42.

The synchronous rotating reference frame transform 38 operates at a selected frequency that corresponds to the dominant or fundamental frequency of the simulation output signal x_{ac}(t) to convert it to multiple simulation output signal components that represent the vector of the simulation output signal x_{ac}(t). These simulation output signal components may represent Cartesian real and imaginary components, polar magnitude and phase components, or components for any other convenient coordinate system.

In FIG. 3, the simulation system 28 uses a polar magnitude and phase coordinate system, wherein the synchronous rotating reference frame transform 38 converts the simulation output signal x_{ac}(t) to simulation output signal components that comprise a baseband simulation output amplitude signal x_{dc}(t) on a simulation output amplitude line 44, a simulation output phase signal θ(t) on a simulation output phase line 46 and a simulation output frequency signal ω(t) on a simulation output frequency line 48. If the dominant or fundamental frequency of simulation output signal x_{ac}(t) varies as a function of time, the synchronous rotating reference frame transform 38 may respond to a frequency tracking signal on a frequency tracking signal line 50 generated by a frequency shift detector 52 that tracks the dominant or fundamental frequency of the simulation output signal x_{ac}(t), such as a phase-locked loop, to change the rate of rotation of its rotating reference frame in response to the frequency tracking signal on the frequency tracking signal line 50 to follow changes in the fundamental frequency of the simulation model output signal x_{ac}(t).

The anti-alias filter 40 receives the baseband simulation output amplitude signal x_{dc}(t) on a simulation output amplitude line 44, the simulation output phase signal θ(t) on a simulation output phase line 46 and the simulation output frequency signal ω(t) on a simulation output frequency line 48 and removes content of these signals above a maximum desired communication frequency f to produce corresponding filtered simulation output amplitude signal x_{dcf}(t) on an amplitude filter output line 54, filtered simulation output phase signal θ_{f}(t) on a phase filter output line 56 and filtered simulation output frequency signal ω_{f}(t) on a frequency filter output line 58.

The sampler 42 receives the filtered simulation output amplitude signal x_{dcf}(t) on an amplitude filter output line 54, filtered simulation output phase signal θ_{f}(t) on a phase filter output line 56 and filtered simulation output frequency signal ω_{f}(t) on a frequency filter output line 58 and samples and holds values of the filtered simulation output amplitude signal x_{dcf}(t), the filtered simulation output phase signal θ_{f}(t) and the filtered simulation output frequency signal ω_{f}(t) at a selected sampling rate k with a frequency of at least the Nyquist Rate, or 2f to produce a sampled output amplitude signal X_{dcf}(k) on a sampler output amplitude line 60, a sampled output phase signal Θ_{f}(k) on a sampler output phase line 62 and a sampled output frequency signal Ω_{f}(k) on a sampler output frequency line 64.

The co-simulation interface 32 receives sampled output amplitude signal X_{dcf}(k) on a sampler output amplitude line 60, a sampled output phase signal Θ_{f}(k) on a sampler output phase line 62 and a sampled output frequency signal Ω_{f}(k) on a sampler output frequency line 64 and transfers them to another simulation 30 by way of respective communication buses 34. An input signal processor 66 receives sampled output amplitude signal X_{dcf}(k) on a sampled amplitude line 68, a sampled output phase signal Θ_{f}(k) on a sampled phase line 70 and a sampled output frequency signal Ω_{f}(k) on a sampled frequency line 72. The input signal processor 66 comprises an amplitude signal reconstruction filter 74, a stationary reference frame transform 76 and a simulation signal reconstruction filter 78.

The amplitude signal reconstruction filter 74 receives the sampled output amplitude signal X_{dcf}(k) on the sampled amplitude line 68 and conditions the sampled output amplitude signal X_{dcf}(k) to produce a conditioned amplitude signal x_{dcs}(t) on a conditioned amplitude signal line 80. The amplitude signal reconstruction filter 74 may be a low-pass filter that filters or smoothes the sampled output amplitude signal X_{dcf}(k).

The stationary reference frame transform 76 receives the conditioned amplitude signal x_{dcs}(t) on the conditioned amplitude signal line 80, the sampled output phase signal Θ_{f}(k) on the sampled phase line 70 and the sampled output frequency signal Ω_{f}(k) on the sampled frequency line 72 and transforms them to a simulation input signal x_{ac}(t) on a stationary reference frame transform output line 82. The simulation signal reconstruction filter 78 receives the simulation input signal x_{ac}(t) on the stationary reference frame transform output line 82 and conditions it to produce a conditioned simulation input signal X_{acs}(t) on a conditioned simulation signal input line 84. The simulation signal reconstruction filter 78 may be a low-pass filter that filters or smoothes the simulation input signal x_{ac}(t). The model 6 receives the conditioned simulation input signal x_{acs}(t) on the conditioned simulation signal input line 84, thereby letting the models 6 of the simulations 30 to communicate and interact.

If the models 6 generate simulation signals with multiple dominant frequencies, such as a fundamental frequency and several harmonics, each simulation 30 may comprise multiple output processors 36 and input processors 66, each corresponding to a different dominant frequency of interest. In this case, a band-pass filter may filter the simulation output signal x_{ac}(t) from each model 6 into frequency component signals at the frequencies of interest and distribute them to corresponding output processors 36. A multiplexer may multiplex the frequency component simulation input signals from the multiple input processors 66 to generate the simulation input signal x_{ac}(t).

The described embodiments of the invention are only some illustrative implementations of the invention wherein changes and substitutions of the various parts and arrangement thereof are within the scope of the invention as set forth in the attached claims.

The claimed invention is:

1. A method of communication and interaction between multiple simulations of a complex simulation system, each simulation comprising a model of a physical subsystem or parameter of the complex simulation system, comprising the steps of:
transmitting from at least one transmitting simulation an output of its model to generate a simulation output signal;
attenuating the simulation output signal above a maximum desired communication frequency between the simulations to generate a corresponding filtered simulation output signal;
sampling the filtered simulation output signal at a sampling rate with a frequency at least twice the maximum desired communication frequency to generate a corresponding sampled output signal;
transferring the sampled output signal from the transmitting simulation to at least one receiving simulation;
conditioning the sampled output signal to generate a simulation input signal; and
transferring the simulation input signal to the model of the receiving simulation.

2. The method of claim 1, wherein the sampling rate is an integer multiple of a discrete-time sample rate of any one of the simulations that is a discrete-time simulation.

3. The method of claim 1, further comprising the steps of:
transforming the simulation model output signal to at least one synchronous rotating reference frame for a corresponding selected reference frequency to generate simulation output signal components that represent the vector of the simulation output signal; and
conditioning the simulation input signal before transfer to the model of the receiving simulation;
wherein the step of attenuating the simulation output signal comprises attenuating the simulation output signal components generates filtered simulation output signal components, the step of sampling the filtered simulation output signal comprises sampling the filtered simulation output signal components, the step of transferring the sampled filtered simulation output signal comprises transferring the sampled filtered simulation output signal components; and the step of conditioning the sampled filtered simulation output signal comprises transforming the sampled filtered simulation output signal components to a simulation input signal in a stationary reference frame.

4. The method of claim 3, wherein the step of transforming the simulation model output signal to a synchronous rotating reference frame comprises a reference frame that rotates at a fundamental frequency of the simulation model output signal.

5. The method of claim 4, further comprising the steps of:
tracking the fundamental frequency of the simulation model output signal to generate a frequency tracking signal; and
changing the rate of rotation of the rotating reference frame in response to the frequency tracking signal to follow changes in the fundamental frequency of the simulation model output signal.

6. The method of claim 3, wherein the step of transforming the simulation model output signal further comprises the step of selecting multiple reference frequencies for multiple synchronous reference frames.

7. The method of claim 6, wherein the selected multiple reference frequencies correspond to the fundamental frequency and selected harmonics of the simulation model output signal.

8. The method of claim 7, further comprising the steps of:
band-pass filtering the simulation model output signal into component signals at the fundamental frequency and selected harmonics; and
transforming each component signal with a corresponding rotating reference frame into component amplitude, phase and frequency signals.

9. The method of claim 8, further comprising the steps of:
transforming each sampled output amplitude, phase and frequency signal for each component signal to a stationary reference frame to corresponding component simulation input signals; and
combining the component simulation input signals to generate the simulation input signal.

10. A method of communication and interaction between multiple simulations of a complex simulation system, each simulation comprising a model of a physical subsystem or parameter of the complex simulation system, comprising the steps of:
transmitting from at least one transmitting simulation an output of its model to generate a simulation model output signal;
transforming the simulation model output signal to a synchronous rotating reference frame for at least one selected reference frequency to generate simulation output signal components that represent the vector of the simulation output signal;
attenuating each simulation output signal component above a maximum desired communication frequency between the simulations to generate corresponding filtered output signal components;
sampling the filtered output signal components at a sampling rate with a frequency at least twice the maximum desired communication frequency to generate a corresponding sampled output signal components;
transferring the sampled output signal components from the transmitting simulation to at least one receiving simulation;
transforming the sampled output signal components to a simulation input signal in a stationary reference frame; and
transferring the simulation input signal to the model of the receiving simulation.

11. The method of claim 10, wherein the step of transforming the simulation model output signal to a synchronous rotating reference frame comprises a reference frame that rotates at a fundamental frequency of the simulation model output signal.

12. The method of claim 10, further comprising the steps of:
tracking the fundamental frequency of the simulation model output signal to generate a frequency tracking signal; and
changing the rate of rotation of the rotating reference frame in response to the frequency tracking signal to follow changes in the fundamental frequency of the simulation model output signal.

13. The method of claim 10, wherein the step of transforming the simulation model output signal further comprises the step of selecting multiple reference frequencies for multiple synchronous reference frames.

14. The method of claim 13, wherein the selected multiple reference frequencies correspond to the fundamental frequency and selected harmonics of the simulation model output signal.

15. The method of claim 14, further comprising the steps of:
band-pass filtering the simulation model output signal into frequency component signals at the fundamental frequency and selected harmonics; and
transforming each frequency component signal with a corresponding rotating reference frame into component amplitude, phase and frequency signals.

16. The method of claim 15, further comprising the steps of:
transforming each sampled output signal component for each frequency component signal to a stationary reference frame to corresponding component simulation input signals; and
combining the component simulation input signals to generate the simulation input signal.

17. The method of claim 10, wherein the simulation output signal components represent amplitude, phase and frequency of the simulation output frequency signal.

18. The method of claim 17, further comprising the steps of:
conditioning the sampled output signal component representing the amplitude of the simulation output signal before the step of transforming the sampled output signal components to the simulation input signal; and
conditioning the simulation input signal before transferring it to the receiving simulation model.

19. A system for communication and interaction between multiple simulations of a complex simulation system, each simulation comprising a model of a physical subsystem or parameter of the complex simulation system, comprising:
a model within at least one transmitting simulation that transmits a simulation model output signal;
a synchronous rotating reference frame transform that transforms the simulation model output signal to at least one synchronous rotating reference frame for a corresponding selected reference frequency to generate a simulation output amplitude signal, a simulation output phase signal and a simulation output frequency signal;
an anti-alias filter that attenuates each simulation output amplitude, output phase and output frequency signal above a maximum desired communication frequency between the simulations to generate corresponding filtered output amplitude, output phase and output frequency signals;
a sampler that samples and holds values of the filtered output amplitude, output phase and output frequency signals at a sampling rate with a frequency at least twice the maximum desired communication frequency to generate a corresponding sampled output amplitude, output phase and output frequency signals;
a communications interface that transfers the sampled output amplitude, output phase and output frequency signals from the transmitting simulation to at least one receiving simulation;
an amplitude signal reconstruction filter that conditions the sampled output amplitude signal after transfer to the receiving simulation;
a stationary reference frame transform that transforms the sampled output amplitude, phase and frequency signals to a simulation input signal in a stationary reference frame;
a simulation signal reconstruction filter that conditions the simulation input signal;
a model in the receiving simulation that receives the conditioned simulation input signal.

20. The system of claim 19, wherein the synchronous rotating reference frame transform rotates at a fundamental frequency of the simulation model output signal.

21. The system of claim 19, further comprising:
a frequency shift detector that tracks the fundamental frequency of the simulation model output signal to generate a frequency tracking signal;
wherein the synchronous rotating reference frame transform changes the rate of rotation of the rotating reference frame in response to the frequency tracking signal to follow changes in the fundamental frequency of the simulation model output signal.

22. The system of claim 19, wherein the synchronous rotating reference frame transform comprises multiple transforms that each correspond to one of multiple selected reference frequencies.

23. The system of claim 22, wherein the selected multiple reference frequencies correspond to the fundamental frequency and selected harmonics of the simulation model output signal.

24. The system of claim 23, further comprising:
a band-pass filter that band-pass filters the simulation model output signal into component signals at the fundamental frequency and selected harmonics;
wherein each synchronous rotating reference transform transforms a corresponding component signal into component amplitude, phase and frequency signals.

25. The system of claim 24, further comprising:
multiple stationary reference transforms that each correspond to one of the component signals, wherein each stationary reference transform transforms each sampled output amplitude, phase and frequency signal for each component signal to a stationary reference frame to corresponding component simulation input signals; and
a multiplexer for combining the component simulation input signals to generate the simulation input signal.
